(19) United States
(12) Patent Application Publication
(10) Pub. No.: US 2004/0182195 A1
(43) Pub. Date: Sep. 23, 2004

(54) Steering wheel cover

(76) Inventor: Lisa Bateman, West Jordan, UT (US)

Correspondence Address: Randall B. Bateman, P.O. Box 1319, Salt Lake City, UT, 84110-1319, US

(21) Appl. No.: 10/393,301

(22) Filed: Mar. 20, 2003

(51) Int. Cl. B62D 1/06

(52) U.S. Cl. 74/558

(57) ABSTRACT

A steering wheel cover includes a body and a closure member which are configured so as to cover a steering wheel. The body can be configured to either reflect or to retain sunlight so as to either prevent a steering wheel from becoming too hot or to keep a steering wheel from becoming to cold. Additionally, the steering wheel cover can be configured in such a manner to be invertible to allow heat reflection or absorption depending on the weather. Additionally the steering wheel cover can be provided with heating elements to keep a steering wheel warm and can be provided with advertisements or other promotional displays.

### BACKGROUND

1. Field of the Invention

The present invention relates to a steering wheel cover for preventing environmental extremes from making a steering wheel uncomfortable. More particularly, the present invention relates to a cover for preventing a steering wheel from becoming too hot or too cold.

2. State of the Art

Most drivers have had the experience of climbing into an automobile during the summer and being mildly burned by the temperature of the seat or steering wheel. Because the dash board and steering wheel are positioned immediately adjacent one of the largest, if not the largest, window in an automobile, there is a tendency for the steering wheel to readily absorb sunlight and generate heat. Furthermore, on many makes of automobiles the steering wheel is black. While a black steering wheel is advantageous in that it shows ware and dirt less than a lighter colored steering wheel, the black color increases the likely hood that the steering wheel will become excessively hot when exposed to direct sunlight. In such instances the steering wheel can get hot even when the temperatures outside the vehicle are relatively mild.

In order to prevent the steering wheel, dash board, etc. from becoming over heated, many people use window shades which fill most, if not all, of the window. Such window shades, however, have certain drawbacks. First, many are awkward to use as they require a piece of cardboard to be folded out several times. Additionally, if they are folded in the wrong direction the window shade will often have a message to call the police for assistance. Furthermore, the window shades generally do not look attractive. Finally, the window shades often are long and stick out from beneath the seat when not in use. Thus, many people choose not to use such a window shade in their vehicle.

Without a window shade the only effective methods for keeping the steering wheel cool are to position the car so that the front window faces away from sunlight or to park under a covering. However, in many situations neither of these options is available. Therefore, a person without a window shade must deal with the difficultly of using a overly hot steering wheel. In some hot climates, such as the South and Southwest, the heat developed in the steering wheel can be so hot as to cause tangible burns to ones hands if care is not taken.

Another problem develops with steering wheels in cold climates. If a vehicle is left outside for a long period of time the steering wheel can be exceedingly cold. While a driver will typically have a coat or other clothing to protect them from the cold of the seat, the hands must be placed on the cold steering wheel. Thus, drivers will often either suffer discomfort or wear gloves while driving. For those suffering from arthritis and other maladies, leaving ones hands on a cold steering wheel can even be painful.

In attempt to resolve some of these concerns various steering wheel wraps have been suggested. Steering wheel wraps are often made of leather or fabric such as carpet or other designs configured to dissipate temperature extremes. However, such covers are generally not removable. Additionally, some of such covers are relatively ugly and do not match the look of the car. For example, one would not expect to see a sports car with a carpet-like steering wheel cover.

Thus, it is desired to provide a device which minimizes the risk of extreme heat or extreme cold in the steering wheel causing discomfort to a driver.

### SUMMARY OF INVENTION

It is an object of the present invention to provide a steering wheel cover for minimizing temperature extremes in a steering wheel.

The above and other objects of the invention are achieved in a steering wheel cover which in configured for covering a steering wheel so as to shield it from the sun or excessive cold. The steering wheel cover preferably includes a body which is made of a flexible material configured for covering a steering wheel and an elastic member attached to the body for applying a retaining force which forms an opening into which the steering wheel in placed.

In accordance with one aspect of the invention, the steering wheel cover is made of a highly reflective fabric so as to reflect sunlight. By reflecting the sunlight, the steering wheel cove prevents excessive heating of the steering wheel.

In accordance with another aspect of the invention the steering wheel cover is formed from an insulating material to thereby minimize temperature change in the steering wheel regardless of whether the exterior temperature is hotter or colder than that of the steering wheel.

In accordance with still another aspect of the invention, the steering wheel cover includes a heat absorbing or retaining material, such as a gel, which absorbs the temperature and radiates the temperature to the steering wheel to maintain a desired temperature in the steering wheel.

In accordance with another aspect of the invention the steering wheel cover includes a power source for generating heat in the steering wheel cover. The heated steering wheel cover can be used to keep the steering wheel from becoming too cold, and thereby preventing the steering wheel from aggravating arthritis and the like.

In accordance with still another aspect of the invention the steering wheel cover may be used as a promotional device for displaying information, such as a team logo, a trade name or trademark, or other kinds of advertising information and the like.

### BRIEF DESCRIPTION OF THE DRAWINGS

The above and other objects, features and advantages of the invention will become apparent from a consideration of the following detailed description presented in connection with the accompanying drawings in which:

FIG. 1 shows a perspective view of a steering wheel cover formed in accordance with the principles of the present invention;

FIG. 2 shows a view of the steering wheel cover of FIG. 1 disposed on a steering wheel;

FIG. 3 shows a partially cut away view of a steering wheel cover in accordance with the principles of the present invention;

FIG. 4 shows and alternate embodiment of a steering wheel cover having a temperature retaining material disposed inside;

FIG. 5 shows a top view of a steering wheel cover configured for heating a steering wheel; and

FIG. 6 shows a top view of a steering wheel cover configured for use as a promotional tool.

### DETAILED DESCRIPTION

The invention will now be described so as to enable one skilled in the art to make and use the invention. It is to be understood that the following description is only exemplary of the principles of the present invention and should not be viewed as narrowing the pending claims. It should further be understood that the various embodiments and examples relate to various aspects of the present invention, and not all embodiments need to achieve all objects of the invention.

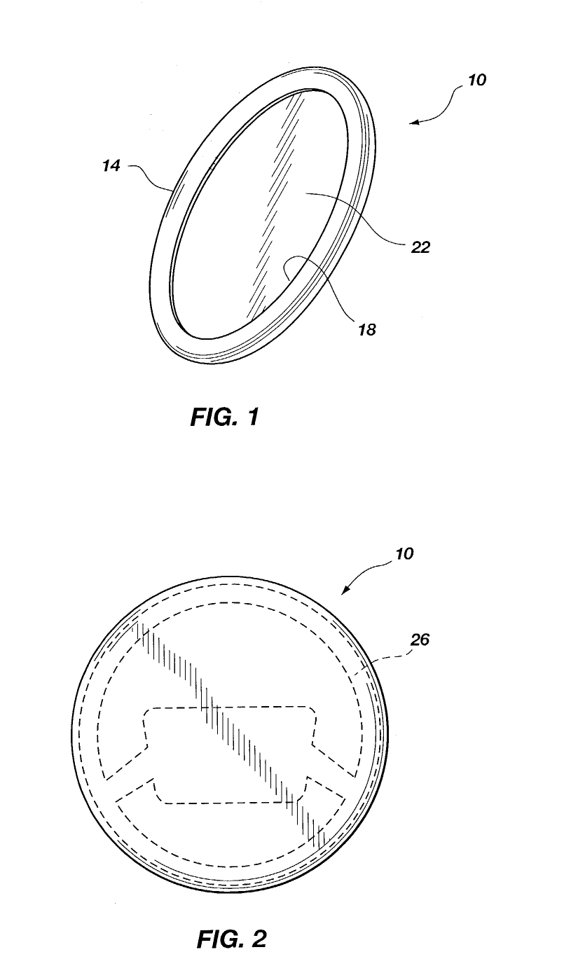

Turning now to FIG. 1 there is shown a prospective view of a steering wheel cover, generally indicated at 10, made in accordance with the principles of the present invention. The steering wheel cover 10 includes a body 14 and a closure member 18. Typically, the closure member 18 will include material such a elastic which is sewn or otherwise attached or enclosed with the steering wheel cover so as to form an opening 22 by which the steering wheel cover is slid over the steering wheel. It will be appreciated that the body 14 can be made from a variety of materials for example, a plain fabric can be used, highly reflective fabric such as metallicized fabric, mylar, or some other highly reflective material can also be utilized to reflect the suns rays. It will also be understood, in light of the present invention that a steering wheel cover could be made of a dark of fabric which is designed to attract heat for use in cold climates so that when a vehicle is left outside in the cold the steering wheel will tend to heat up or stay warm due to solar radiation generating heat within the black material.

It will be appreciated that whatever material is used it will be desirable that the material forming the body 14 should be flexible so as to allow it to slip over and, preferably, somewhat conform the shape of the steering wheel. However, it may be desirable in extremely hot climates for the steering wheel cover to be somewhat baggy so that any heat that is developed is not transferred directly to the steering wheel.

Turning now to FIG. 2 there is shown a view of the steering wheel cover 10 disposed on a steering wheel indicated by the dashed lines 26. The steering wheel cover 10 is mounted on the steering wheel by simply pulling on the elastic (not shown) or other closure member sufficiently that the steering wheel 26 can be slid into the opening (not shown in FIG. 2). The elastic is then drawn over the opposing side of the wheel and released so that the elastic or other closure member can draw the steering wheel cover into place.

As the steering wheel cover 10 remains in place, the steering wheel 26 is protected from direct sunlight. Therefore, the risk that the steering wheel 26 will become excessively hot is virtually eliminated. Likewise, if the steering wheel cover 10 is made of material having heat retention properties, placing the steering wheel cover over the steering wheel 26 will provide insulation and minimize the risk of the steering wheel becoming excessively cold.

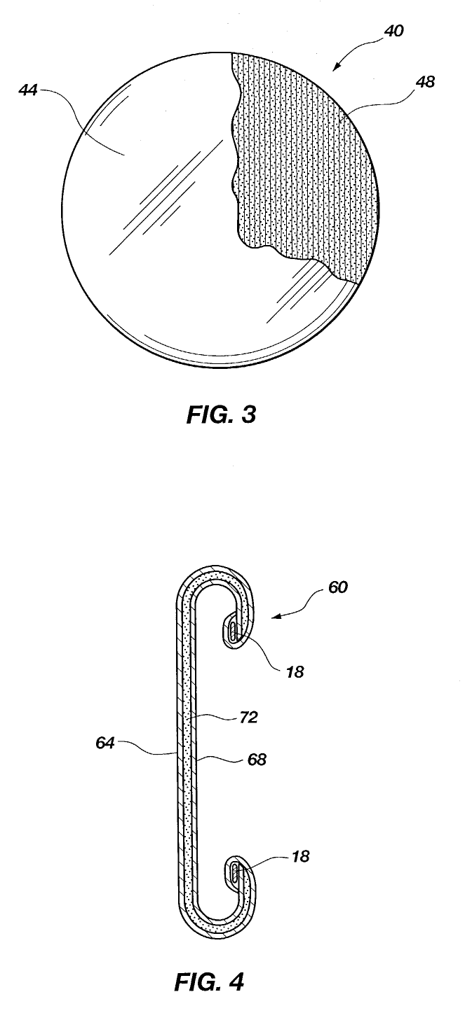

Turning now to FIG. 3 there is shown a alternate configuration of the invention. The steering wheel cover, generally indicated at 40, is provided with a first highly reflective layer 44 and a second non-reflective layer 48. The first layer 44 is preferably made from metallicized fabric, mylar or other highly reflective material. Preferably such material is not highly insulating.

The second layer 48 is made from a material which is dark so as to attract heat. Additionally, the second layer 48 may having insulating qualities.

In use, the steering wheel cover 40 may be used as shown so that the first layer 44 is disposed on the outside of the steering wheel cover. The highly reflective material of the first layer 44 reflects sunlight away from the steering wheel and thereby prevents the steering wheel from becoming overly heated. The second layer 48 further insulates the wheel from heat.

In the event that temperature has changed and the desire to keep the steering wheel from getting too cold, the steering wheel cover 40 may be inverted be simply pushing the body through the opening so that the dark colored second layer 48 is disposed on the outside. As the dark layer is positioned over the steering wheel, the dark layer both tends to insulate the steering wheel against loss of heat and generates heat due to receiving solar radiation impacting on the dark coloring. Thus, a single steering wheel cover can be used in climates which see both hot and cold temperature extremes.

Turning now to FIG. 4, there is shown an alternate embodiment of the invention. The steering wheel cover generally indicated at 60, includes an outer layer 64 and an inner layer 68. Between the inner layer 64 and the outer layer 68 is an insulating material or heat/cold absorbing material 72. Shown in FIG. 4 the insulating material 72 is a gel. However, other materials can be used.

As the steering wheel cover 60 is used, the insulating material 72 will provide heat to the steering wheel to prevent it from becoming excessively cold and will draw heat away from the steering wheel to prevent it from becoming excessively warm. The effect of the gel or other insulating material 72 can further be enhanced by placing it next to the heater or air conditioning while the car is in use so that the gel or other insulating is either warm or cool when the automobile is in use. Placing the steering wheel cover 60 on the steering wheel then tends to maintain the steering wheel in contrast to the environmental conditions.

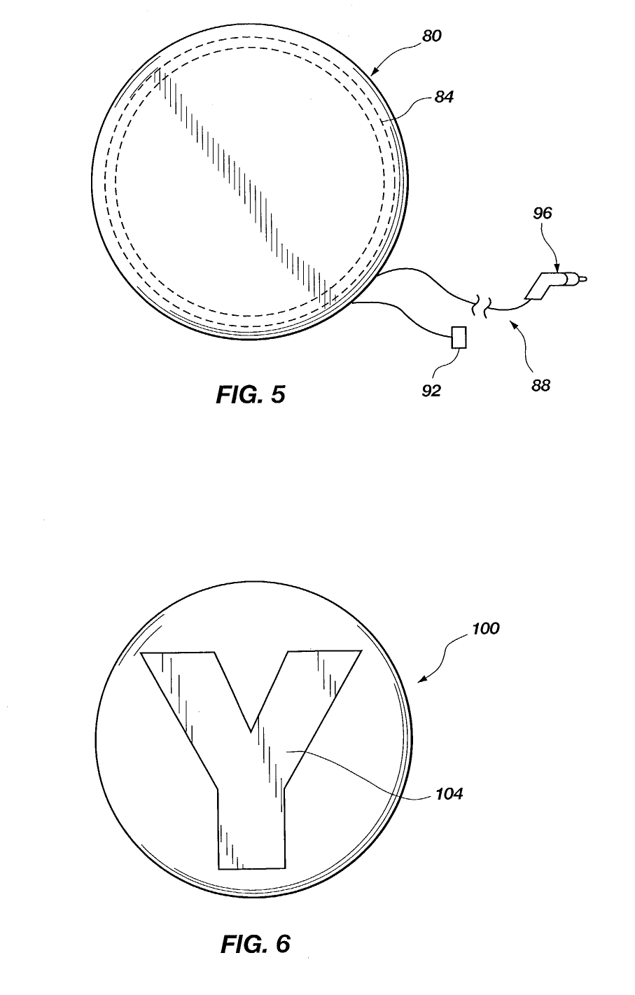

Turning now to FIG. 5, there is shown an alternate embodiment of the present invention in which a steering wheel cover, generally indicated at 80, is provided with a plurality of heating elements indicated by dash lines 84. The heating elements are connected to a power supply 88. The power supply may either be a battery shown at 92 or an alternate power source, such as a cigarette lighter adaptor 96. By using the steering wheel cover 80, the steering wheel can be kept warm even when the vehicle is outside for a long period of time in very cold weather. Additionally, such configuration is highly advantageous for less expensive automobiles which lack highly efficient heating systems, heated seats and the like. As long as the users hands are warm and comfortable the few minutes it takes to warm up the car are generally not of concern.

In addition to the practical advantages of a steering wheel cover in accordance with the present invention, the steering wheel cover can also be used for promotional purposes. For example, in FIG. 6, there is shown a steering wheel cover generally indicated at 100, which is configured with a college logo 104. The logo is printed so that when the steering wheel cover is placed on the steering wheel the logo is clearly visible to those passing by the vehicle. In addition to college logos, the steering wheel cover 100 can be used with other promotional items, such as the trademarks or trade names of companies, etc. Thus, for example, a car dealership may include a steering wheel cover to further promote services. Likewise other companies may use it for advertising their goods or services.

Thus, there is disclosed a steering wheel cover which makes use of the steering wheel more comfortable. Such a steering wheel cover is relatively inexpensive and can be used regardless of the age of the vehicle. Those skilled in the art will appreciate numerous modifications which may be made without departing from the scope or the spirit of the invention. The appended are intended to cover such modifications.

What is claimed is:

1. A steering wheel cover comprising:
a body formed of generally flexible material for disposition over a steering; and
a closure member disposed about the body so as to form an opening therein, the opening being sufficiently large for a steering wheel to be slipped therethrough.

2. The steering wheel cover of according to claim 1, wherein the steering wheel cover is made from an insulating material.

3. The steering wheel cover according to claim 1 wherein the steering wheel cover is made from a highly reflective material.

4. The steering wheel cover according to claim 1 wherein the steering wheel cover is made from a first layer which is highly reflective and a second layer which absorbs light.

5. The steering wheel cover according to claim 1, wherein the steering wheel cover comprises a first layer, a second layer, and a insulated material disposed between the first layer and the second layer.

6. The steering wheel cover according to claim 5 wherein the insulated material comprises a gel.

7. The steering wheel cover according to claim 1, wherein the steering wheel cover comprises a plurality of heating elements.

8. The steering wheel cover according to claim 7, wherein the heating elements are attached to a power source.

9. The steering wheel cover according the claim 8, wherein the power source comprises a battery.

10. The steering wheel cover according to claim 8 wherein the power source comprises a cigarette lighter adaptor.

11. The steering wheel cover according to claim 1, wherein the cover further comprises an advertisement as disposed on the steering wheel cover.

12. The steering wheel cover according to claim 11 wherein the advertisement comprises a name or logo.

13. The steering wheel cover according to claim 11 wherein the advertisement comprises a trademark or trade name.

14. A method for preventing extreme temperatures in a steering wheel, the method comprising:
selecting a steering wheel; and
placing a steering wheel cover having a body and a closure member over the steering wheel cover so that the body covers the steering wheel.

15. A method according to claim 14, wherein the method comprises selecting a steering wheel cover which is formed a highly reflective material.

16. The method according to claim 14, wherein the method comprises selecting a cover made from an metallicized material.

17. The method according to claim 14, wherein the method comprises selecting a cover having a first layer and a second layer, the first layer being highly reflective and the second layer being dark.

18. The method according to claim 14, wherein selecting a steering wheel cover comprises selecting a steering wheel cover having an insulated material disposed therein.

19. The method according to claim 14, wherein the method comprises selecting a steering wheel cover having heating elements disposed therein and wherein the method further comprises utilizing a power source to heat the heating elements.

20. The method according the claim 14, wherein the method comprises selecting a steering wheel cover having a advertisement thereon the method further comprises selecting a steering wheel cover having an advertisement disposed thereon the method further comprising positioning the steering wheel cover on the steering wheel so that the advertisement clearly visible outside the car.
